(19) United States
(12) Patent Application Publication
(10) Pub. No.: US 2026/0076313 A1
(43) Pub. Date: Mar. 19, 2026

(54) Agricultural coloration method

(71) Applicant: SUN'AGRI, PARIS (FR)

(72) Inventors: Gerardo Lopez Velasco, MONTPELLIER (FR); Perrine Juillion, Lyon (FR); Damien Fumey, Montpellier (FR)

(21) Appl. No.: 19/326,790

(22) Filed: Sep. 12, 2025

(30) Foreign Application Priority Data
Sep. 17, 2024 (FR) 2409878

(51) Int. Cl. A01G 9/24; A01G 7/04

(52) U.S. Cl. CPC A01G 9/249; A01G 7/045; A01G 9/243

(57) ABSTRACT

A method is provided for achieving coloration of fruits (F) of plants (A), notably fruit trees, located underneath orientable photovoltaic collectors (C). The shade cast on the plants is modified by changing the orientation of the collectors (C), where the orientation of the collectors is automatically acted on depending on the coloration state of the fruits (F) so as to increase insolation with respect to a reference collector control state applied when the desired coloration has been reached or when the fruits are not yet colored, with a view to promoting the action of the sun on coloration.

### RELATED APPLICATION

This application claims priority to French Patent Application No. 24 09878, filed on Sep. 17, 2024, the entirety of which is incorporated reference.

### TECHNICAL FIELD

The present invention relates to the coloration of fruits in agriculture.

### PRIOR ART

The coloration of fruits is a natural process that occurs as the fruits ripen. It is a significant visual change that accompanies ripening of fruits and is often used as an indicator of their state of maturity. The coloration of fruits is mainly due to changes in pigments present in the cells of the fruit. The synthesis or degradation of these pigments may be influenced by various factors such as temperature, light, humidity, and the level of maturity of the fruit itself. For example, certain environmental conditions, such as cold temperatures, may delay or alter the coloration of fruits. The coloration of fruits is often a sign of maturity, meaning that the fruit is ready to be eaten. However, this is not always the case for all fruits. Some fruits may be picked before they reach their ultimate coloration and will ripen more after harvesting.

Patent application CN104641990 discloses a flowerpot base rotating device for controlling uniform irradiation of plants. By virtue of this device, damage that might be caused to plants due to strong or prolonged irradiation is avoided. Thus, flowers and fruits can be uniformly colored.

### SUMMARY OF THE INVENTION

There is a need to further improve methods for achieving coloration of fruits of plants, notably fruit trees, that in particular are located underneath photovoltaic collectors, in order to optimize the coloration process while still generating electrical power.

The invention aims to meet this objective and, according to one of its aspects, relates to a method for achieving coloration of fruits of plants, notably fruit trees, located underneath orientable photovoltaic collectors, the shade cast on the plants being modified by changing the orientation of the collectors, in which method the orientation of the collectors is automatically acted on depending on the coloration state of the fruits so as to increase insolation with respect to a reference collector control state applied when the desired coloration has been reached or when the fruits are not yet colored, with a view to promoting the action of the sun on coloration.

The invention thus makes it possible to take advantage of the presence of photovoltaic collectors to promote the action of the sun on coloration.

Preferably, the orientation of the photovoltaic collectors is controlled on the basis at least of data representative of phenological stages of the plants, notably the coloration state of the fruits, the indicators of the coloration state of the fruits notably comprising their colors and/or the size of the organs constituting them and/or the number of colored fruits with respect to the total number of fruits.

The phenological stage of a plant refers to the specific phase of its growth and development cycle. It describes where the plant is in its biological cycle depending on the weather conditions, the season and other environmental factors.

The phenological stages of a plant include multiple key steps such as dormancy, germination, plant development and flowering.

Preferably, the orientation of the collectors is acted on while at the same time seeking to maximize the generation of electrical power with respect to a reference without combination with plants.

The collectors may be controlled depending on the outside temperature and/or on the day of the week, notably with a view to reducing the shade generated by the collectors at times when demand for electrical power is low.

In one embodiment, the photovoltaic collectors are oriented so as to cast as little shade as possible on plants the fruits of which have not yet reached the desired coloration.

When the fruits have not reached the desired coloration, the photovoltaic collectors are preferably oriented so as to generate a maximum of electrical power at least during a predefined time range, notably between ten o'clock in the morning and four o'clock in the afternoon, and when the fruits are reaching the desired coloration, the photovoltaic collectors are oriented so as to decrease the shade that they generate during said time range.

Preferably, at least one camera is used to acquire images of the plants and to track the coloration state of the fruits. The method notably comprises automatically processing the images from the camera with a view to detecting the stage of coloration and to generating a piece of information based on which the collectors are controlled.

The images taken by the camera are preferably compared to reference images indicating coloration state.

The images taken by the camera may be segmented to identify the fruits.

The images taken by the camera may be processed by colorimetry to analyze the colors of the fruits. The dimension and/or color of the organs of the fruit may be used as an indicator to determine the stage of coloration.

In one embodiment, if the images taken by the camera show that at least 20% of the total number of fruits present in the field of view of the camera have not yet reached the desired coloration, then a collector control mode promoting coloration is activated.

The coloration state may be periodically re-evaluated during fruitage, notably every day.

In one embodiment, an application intended to be run on a mobile terminal is made available to at least one user with a view to allowing at least one piece of information relating to the coloration state of the fruits to be entered, this piece of information being transmitted to a system for controlling the collectors.

The application is preferably configured to automatically geolocate the mobile terminal, and the terminal transmits at least one piece of information relating to the coloration state of the fruits, and a piece of information on the location of the terminal.

At least one photograph of the plants may be taken with the mobile terminal, this photograph being automatically analyzed to deduce therefrom at least one piece of information regarding the coloration state of the fruits, the photograph preferably being geolocated.

The plants may be selected from the following: fruit trees, notably pome and stone fruit trees, in particular apple trees, pear trees, plum trees, apricot trees, fig trees, kiwi-fruit trees, cherry trees, mandarin trees, clementine trees and peach trees.

The invention also relates, according to another of its aspects, to a method for cultivating plants underneath orientable photovoltaic collectors, wherein these plants are grown while at the same time acting on the coloration of their fruits by implementing the coloration method according to the invention.

### BRIEF DESCRIPTION OF THE DRAWINGS

The invention may be understood better from reading the following detailed description of nonlimiting implementation examples thereof, and from examining the appended drawing, in which:

FIG. 1 schematically shows a system for controlling the orientation of a photovoltaic collector according to the invention; and

FIG. 2 is a schematic view of a system for generating electrical power comprising photovoltaic collectors allowing the coloration method according to the invention to be implemented.

### DETAILED DESCRIPTION

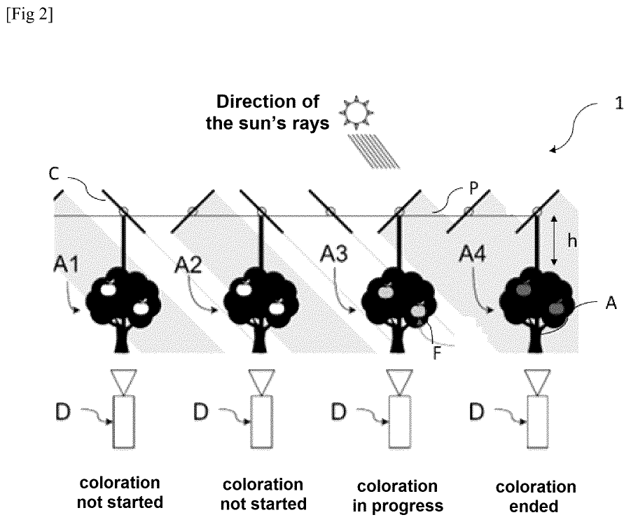

FIG. 2 schematically illustrates a system 1 for generating electrical power comprising a supporting structure P and orientable photovoltaic collectors C that are kept at a non-zero distance from the ground by the supporting structure P, and at a height h from fruit trees A, for example apple trees, which comprise fruits F and which are located underneath the collectors C. The shade from the sun cast on the plants is modified by changing the orientation of the collectors C.

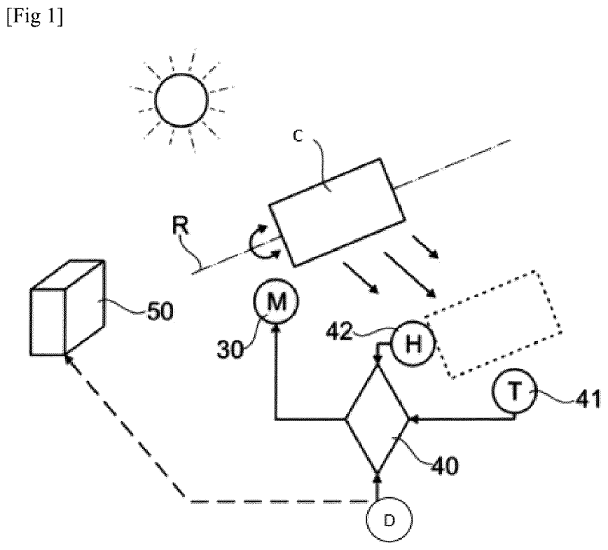

FIG. 1 shows one of these photovoltaic collectors C which is movable about an axis of rotation R. The photovoltaic collector C is pivoted about the axis R by means of at least one actuator 30. For example, an actuator 30 is provided individually for each photovoltaic collector C. As a variant, the same actuator 30 may rotate a plurality of photovoltaic collectors C.

The actuators 30 each comprise for example one or more electric motors, and for example consist of servomotors.

The position to be given to the photovoltaic collector C may be determined by a local computer 40 that is connected via any suitable power interface to the actuator 30.

The computer 40 preferably receives weather information, notably from one or more local sensors, for example a temperature sensor 41 and a humidity sensor 42. Other sensors may be added to examine the weather conditions, such as a rain gauge, anemometer, and/or a camera D for acquiring images and viewing the state of development of the plant and coloration state, and also one or more biosensors, where appropriate. Said camera D may be either supported by the structure P or by another separate structure, or by a drone.

The computer 40 may also exchange data, for example via a wireless phone network, with a remote server 50, which may for example provide the computer 40 with information about the coming weather. The local data relating to temperature and wind may thus come from a remote weather server.

The computer 40 may be any micro-computer or computer equipment allowing the orientation of the photovoltaic collectors C to be controlled according to one or more control laws that set the orientation to be given to the photovoltaic collectors depending on data representative of phenological stages of the plants, notably coloration state, the indicators of the coloration state of the fruits in particular comprising their colors and/or the size of the organs constituting them and/or the number of colored fruits with respect to the total number of fruits. The orientation to be given to the photovoltaic collectors C may also be controlled depending on the plant variety, the weather conditions, and/or coloration state. The computer 40 may be configured to process images delivered by the camera D in order to determine coloration state.

Alternatively, a human operator observes the coloration state, for example on a reference branch, and, if the coloration level corresponds to the existence of the desired population of fruits to be colored, flags that it is possible to activate a collector control mode promoting coloration, by means of a mobile application connected to the computer 40.

The computer 40 may comprise a computing unit and a local memory in which local data relating to the plants and/or to their environment may be stored.

The memory of the computer may also contain automatic-control parameters which regulate the orientation of the photovoltaic collectors C depending on coloration objectives. These parameters may vary over time and for example depending on season, and prioritize coloration or not of the fruits of the plants.

The control law(s) may be programmed into the computer 40 from the very start, or as a variant be downloaded by the computer 40 from the remote server 50, or else be updated periodically by the remote server 50.

In one exemplary embodiment, the computer 40 operates autonomously. Depending on the season, on the sowing date, on the number of fruits present and/or on the coloration state, and possibly on other parameters provided by the grower, it automatically controls the orientation of the photovoltaic collectors C daily or with another frequency such that the coloration objective is met over a given period.

The computer 40 is configured to process the images acquired by the camera D and identify the coloration state by comparing these images with reference images. The images acquired may be segmented to identify the fruits. The images may be processed by colorimetry to analyze the colors of the fruits. The dimension and/or color of the organs of the fruit may be used as an indicator to determine the stage of coloration.

Depending on the coloration state, the collectors C are oriented either to cast as much shade as possible on the trees A, or to minimize the shade cast by allowing light to pass and thus promote coloration of the fruits by the sun.

For example, if the images taken by the camera D show that the required population of fruits is ready to be colored, then a collector control mode promoting coloration is activated.

When this control mode is activated, the photovoltaic collectors C are for example oriented for several days to promote the passage of light to the greatest possible extent. Next, once the sought coloration has been obtained, the photovoltaic collectors C are for example controlled, by activating the actuators 30, so as to give them an orientation aiming to let as little light as possible pass, maximizing electricity generation.

FIG. 2 shows that, when coloration is in progress, the collectors C are oriented in the direction of the rays of the sun, thus casting as little shade as possible on the tree A3. In contrast, when coloration has not commenced yet or has already ended, the collectors are oriented so as to cast as much shade as possible on the trees A1, A2 and A4.

1. A method for achieving coloration of fruits of plants located underneath orientable photovoltaic collectors, said method comprising the steps of:
modifying the shade cast on the plants by changing the orientation of the collectors, wherein the orientation of the collectors is automatically acted on depending on the coloration state of the fruits so as to increase insolation with respect to a reference collector control state applied when the desired coloration has been reached, or when the fruits are not yet colored, in a manner to promote the action of the sun on coloration.

2. The method as claimed in the claim 1, the orientation of the photovoltaic collectors being controlled on the basis at least of data representative of phenological stages of the plants, the indicators of the coloration state of the fruits including their colors and/or the size of the organs constituting them and/or the number of colored fruits with respect to the total number of fruits.

3. The method as claimed in claim 1, wherein the orientation of the collectors is acted on while at the same time seeking to maximize the generation of electrical power with respect to a reference without combination with the plants.

4. The method as claimed in claim 3, wherein the collectors are controlled depending on the outside temperature and/or on the day of the week for reducing the shade generated by the collectors at times when demand for electrical power is low.

5. The method as claimed in claim 1, the photovoltaic collectors being oriented so as to cast as little shade as possible on plants the fruits of which have not yet reached the desired coloration.

6. The method as claimed in claim 1, wherein, when the fruits have not reached the desired coloration, the photovoltaic collectors are oriented so as to generate a maximum of electrical power at least during a predefined time range, and when the fruits are reaching the desired coloration, the photovoltaic collectors are oriented so as to decrease the shade that they generate during said time range.

7. The method as claimed in claim 1, wherein at least one camera is used to acquire images of the plants and to track the coloration state of the fruits, the method further comprising automatically processing the images from the camera for detecting the stage of coloration and to generating a piece of information based on which the collectors are controlled.

8. The method as claimed in claim 7, wherein the images taken by the camera are compared to reference images indicating coloration state.

9. The method as claimed in claim 7, wherein the images taken by the camera are segmented to identify the fruits.

10. The method as claimed in claim 7, wherein the images taken by the camera are processed by colorimetry to analyze the colors of the fruits.

11. The method as claimed in claim 7, wherein, if the images taken by the camera show that at least 20% of the total number of fruits present in the field of view of the camera have not yet reached the desired coloration, then a collector control mode promoting coloration is activated.

12. The method as claimed in claim 1, wherein the coloration state is periodically re-evaluated during fruitage.

13. The method as claimed in claim 1, wherein an application intended to be run on a mobile terminal is made available to at least one user for allowing at least one piece of information relating to the coloration state of the fruits to be entered, this piece of information being transmitted to a system for controlling the collectors.

14. The method as claimed in claim 13, wherein the application is configured to automatically geolocate the mobile terminal, and wherein the terminal transmits at least one piece of information relating to the coloration state of the fruits, and a piece of information on the location of the terminal.

15. The method as claimed in claim 13, wherein at least one photograph of the plants is taken with the mobile terminal, and wherein this photograph is automatically analysed to deduce therefrom at least one piece of information regarding the coloration state of the fruits, the photograph preferably being geolocated.

16. The method as claimed in claim 1, wherein the plants are selected from the group consisting of: fruit trees, pome and stone fruit trees, apple trees, pear trees, plum trees, apricot trees, cherry trees, mandarin trees, clementine trees and peach trees.

17. A method for cultivating plants underneath orientable photovoltaic collectors, said method comprising the steps of:
growing these plants; and
at the same time, acting on the coloration of their fruits by implementing the coloration method as claimed in claim 1.
